(19) United States
(12) Patent Application Publication
(10) Pub. No.: US 2011/0131201 A1
(43) Pub. Date: Jun. 2, 2011

(54) Supply Chain Digital Map Management System and Integrating Method Therefor

(75) Inventor: Pei-Chieh LIN, Taichung (TW)

(73) Assignee: UNIVERSAL CARBON CONTROL TECHNOLOGY CO., LTD., Taichung City (TW)

(21) Appl. No.: 12/873,486

(22) Filed: Sep. 1, 2010

Related U.S. Application Data
(60) Provisional application No. 61/264,857, filed on Nov. 30, 2009.

(51) Int. Cl. G06F 17/30

(52) U.S. Cl. 707/722; 707/E17.044

(57) ABSTRACT

The present invention discloses a supply chain digital map management system, which comprises a site database comprising basic records of vendors and an environment database comprising geographical features and atmosphere conditions that correspond to locations of the vendors. The supply chain digital map management system further comprises a processor which communicates with the site database and the environment database. As BOM tables, the vendor lists of a production are inputted into the processor, the supply chain structure is transferred and shown on the digital map. The supply chain digital map management shows the potential risks on the digital map with different colors/types of marking lines.

### BACKGROUND OF THE INVENTION

1. Field of the Invention

The present invention relates to a supply chain structure; in particular, it relates to a supply chain structure shown on a digital map.

2. Description of Related Art

Supply chain management practices has been implemented for several years, many sketch methods of the supply chain structure related enterprises management theorem are presented. As illustrated in FIG. 1, a first conventional supply chain structure, the scholar Coyle (1996) had provided a sketch method of a supply chain structure based on foods industry. The structure is simplified by using the actual information flow and only presents the main subjects of the food industry. As illustrated in FIG. 2, a second conventional supply chain structure, Joglekar (1998) provided another sketch method of a supply chain structure based on personal computer industry. The structure appropriately shows the operation process of raw material to the end customer, and the inventory condition at the workflow is also shown. According to the workflow, the raw material is transferred into assembly and is processed to be a production, and then the production is distributed or transported via a dealer chain to a customer in accordance with the final requirement. Besides that, the structure can not indicate the factor of “time” and complication of inbound logistics/outbound logistics. As illustrated in FIG. 3, a third conventional supply chain structure, Scott and Westbrook (1991) provided a supply chain structure that involves “process time” and “inventory time”, wherein the horizontal line represents process time, which includes time spent on the manufacturing, assembly, and transportation, the vertical line represents inventory time. On the supply chain structure, the optimized proportion of the process time to inventory time is 1:1. The supply chain structure includes three workflows including workflow 1, workflow 2, and workflow 3 from a factory to a customer site with different processing time and inventory time.

Accordingly, these prior researches of supply chain structures could not show the potential risks. The potential risks, damages from geographical features and atmosphere conditions may always delay or interrupt the process of the manufacturing, assembly, and transportation. Therefore the present invention discloses a supply chain structure that not only presents potential risks, but also shows the actual distances thereof so as to cure the drawbacks of the conventional supply chain structure.

### SUMMARY OF THE INVENTION

Regarding to the aforementioned conventional drawbacks, the objective of the present invention is to provide a supply chain digital map management system so as to present the actual look of a supply chain structure of a certain production by utilizing a digital map.

According to the objective of the present invention, a supply chain digital map management system is herein provided, which comprises a site database comprising basic records of the vendors and an environment database comprising geographical features and atmosphere conditions that correspond to locations of aforementioned vendors. In particular, the geographical features contain seismic belt distribution, geology, and soil condition data that correspond to the locations of the vendors. Furthermore, the atmosphere conditions contain typhoon, floods, and tsunami records that correspond to the locations of the vendors.

According to the objective of the present invention, the supply chain digital map management system further comprises a processor which communicates with the site database and the environment database. In addition, the processor includes a digital map to show a supply chain structure. As BOM tables and vendor lists of a production are inputted into the processor, the processor subsequently automatically compares the BOM tables with the site database and the environment database. As a result, the actual locations of several vendors are shown on the digital map. At the same time, if the locations near or around the vendors have potential risks, such as typhoons, then the degrees of the potential risks are shown on the digital map as different colors/types marking lines.

According to the objective of the present invention, the digital map is a three-dimension map, wherein the supply chain structure is centered at a factory that fabricates the production and the locations of several vendors are marked on the digital map according BOM (Bill of Materials) tables of the production. Furthermore, several different marking lines that connect the factory with the vendors are presented to form a frame of basic supply chain structure. General speaking, in accordance with the present invention, the marking lines are denoted by different colors if the potential risks are caused by geographical features, such as seismic belt. Otherwise, the marking lines are denoted by different types if the potential risks are caused by atmosphere conditions, such as typhoon, floods, and tsunami. If the locations of the vendors or transportation path from the factory to the vendors have no potential risks or other issues, the marking lines can be denoted by normal line. In addition, the actual distances that correspond to aforementioned marking lines are also calculated.

In summary of the descriptions set forth hereinbefore, the supply chain digital map management system according to the present invention allows one or more of the following advantages:
(1) The supply chain digital map management system integrates potential risks and actual geographical features into the supply chain structure.
(2) The supply chain digital map management system shows the degrees of the potential risks on the digital map with different colors/types of marking lines.
(3) According to the supply chain digital map management system, the vendor lists of a production are also obtained from the labels/seals of assemblies by decomposing the production, which is so-called “reverse engineering.”
(4) The digital map of the supply chain digital map management system is a three-dimension map.
(5) According to the supply chain digital map management system, the actual distances that correspond to the marking lines of the supply chain structure are also calculated.
(6) According to the supply chain digital map management system, the carbon emission during the transportation of the production also can be estimated.
(7) The supply chain digital map management system further shows the path of the finished production that is delivered to a stock at the inbound warehouse, and transportation path of the finished production to the customer site via the logistics center.

### BRIEF DESCRIPTION OF THE DRAWINGS

FIG. 1 shows a first conventional supply chain structure.

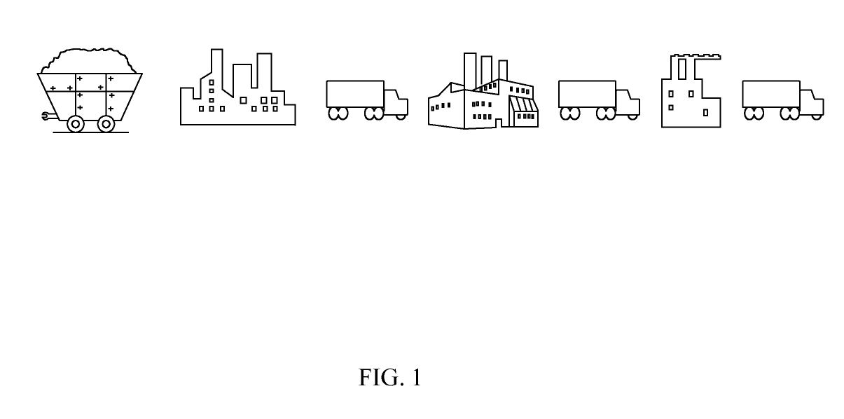

FIG. 2 shows a second conventional supply chain structure.

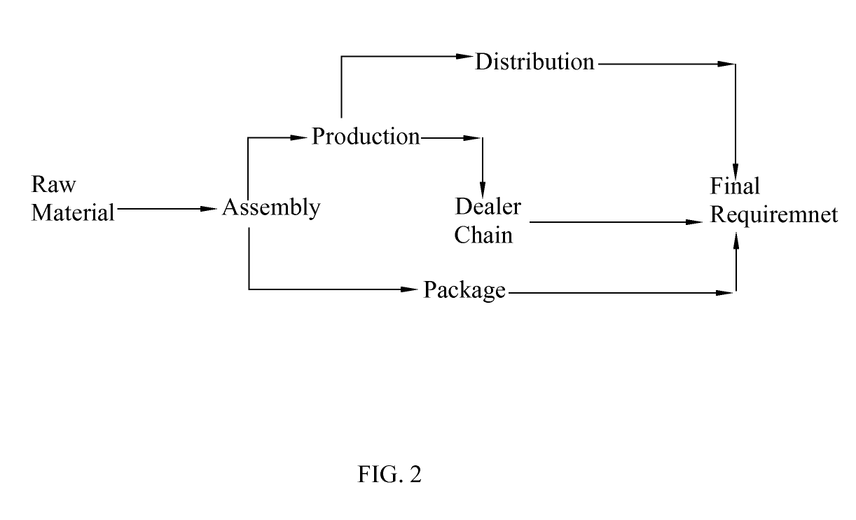

FIG. 3 shows a third conventional supply chain structure.

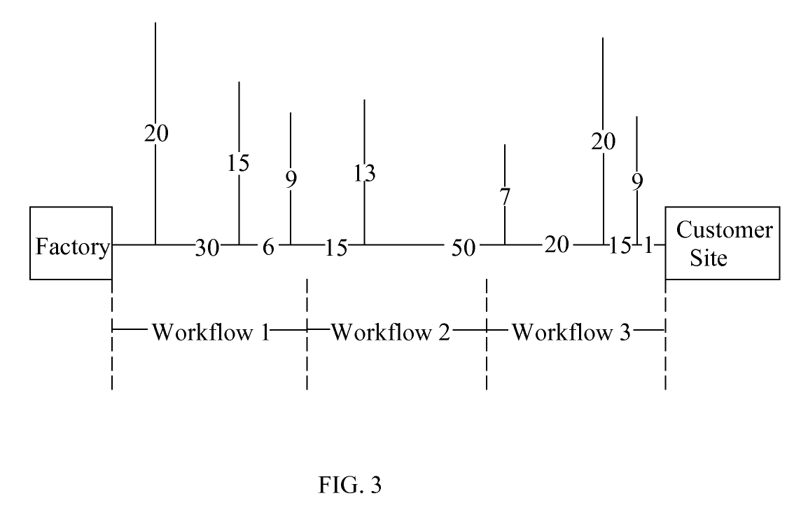

FIG. 4 is a block diagram showing a supply chain digital map management system according to the present invention.

FIG. 5 is a schematic view showing a supply chain structure on a digital map according to the present invention.

FIG. 6 is an actual view showing a supply chain structure on a digital map according to the present invention.

### DETAILED DESCRIPTION OF THE PREFERRED EMBODIMENTS

The present invention provides a supply chain digital map management system to present the actual look of a supply chain structure of a certain production by utilizing a digital map. In order to overcome the well-known drawbacks of conventional supply chain structures, the present invention provides a site database and an environment database according to the locations of several vendors/manufacturers. The site database comprises basic records of the vendors, wherein these records can be the longitude, latitude, and elevation information of the vendors. In addition, the environment database comprises geographical features and atmosphere conditions that correspond to the locations of aforementioned vendors. In particular, the geographical features contain data of seismic belt distribution, geology, and soil condition that correspond to the locations of the vendors; furthermore, the atmosphere conditions contains typhoon, floods, and tsunami records that correspond to the locations of the vendors. Therefore, the present invention not only marks the complication of the inbound logistics/outbound logistics and the stocks/fabrication on the supply chain structure, but also integrates potential risks and actual geographical features into the supply chain structure.

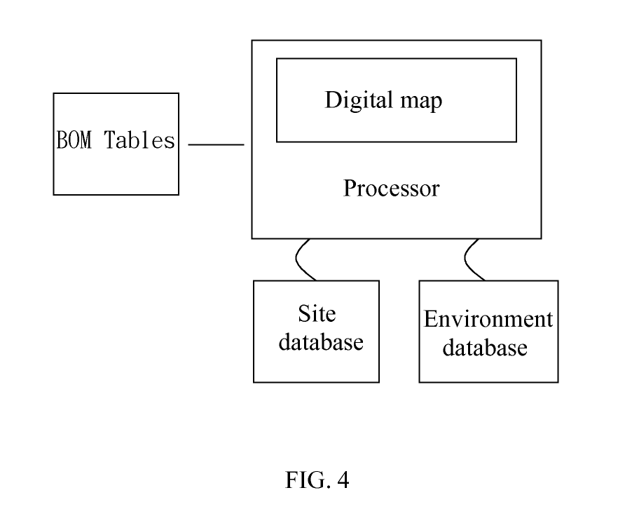

FIG. 4 is a block diagram showing a supply chain digital map management system according to the present invention. As illustrated in FIG. 4, a processor which is communicated with the site database and the environment database is shown; in addition, the processor includes a digital map that shows a supply chain structure. Accordingly, the geographical locations information, such as longitude, latitude, elevation and so forth, of the vendors are established in the site database. As a result, the geographical features and atmosphere conditions near or around the locations of the vendors are established in the environment database. As BOM (Bill of Materials) tables and vendor lists of a production are inputted into the processor, the processor subsequently, automatically compare the BOM tables with the site database and the environment database. As a result, the actual locations of several vendors can be figured out, and the supply chain structure is also transferred on the digital map. At the same time, if the locations near or around the vendors have potential risks, such as typhoons, then the potential risks degrees can be marked on the digital map by the use of different colors/types of marking lines.

According to the present invention, if there are no BOM tables provided, then the vendor lists of a production can also be obtained from the labels/seals of assemblies by decomposing the production, which is so-called “reverse engineering”. Because each of the labels/seals shows the certain vendor that corresponds to the relevant assembly, the estimation of the whole vendor lists of one production is possible.

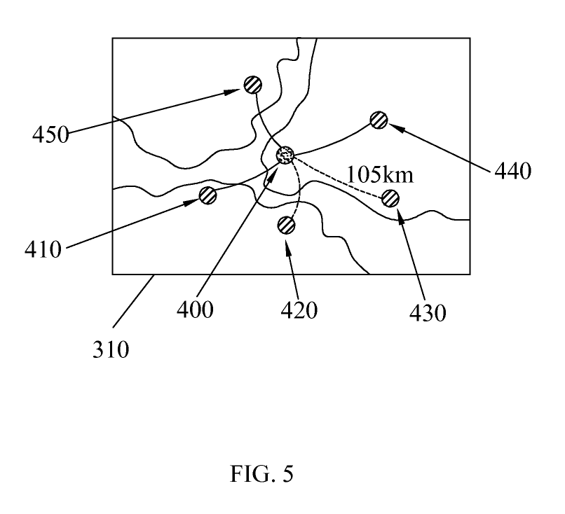

FIG. 5 is a schematic view showing a supply chain structure on a digital map according to the present invention. As illustrated in FIG. 5, a supply chain structure of a production is shown on a digital map 310, a three-dimension map, wherein the supply chain structure is centered at a factory 400 that fabricates the production. According to BOM tables of the production, for example, the locations of five vendors 410-450 are marked on the digital map 310. Furthermore, several different marking lines that connect the factory 400 with the vendors 410-450 are presented to form a schematic frame of basic supply chain structure. As discussed heretofore, the marking lines may have different colors/types to distinguish different potential risks from one another. For example, according to environment database, the vendors 410 and 450, which locate at seismic belt that has high earthquake-occurred frequency, the marking lines between the factory and the vendors 410 and 450 are colored in “Red”. In addition, if the vendor 420 is located at the floods area, the marking line between the factory 400 and the vendor 420 is denoted by a dotted line. General speaking, in accordance with the present invention, the marking lines are indicated with different colors if the potential risks are caused by geographical features, such as seismic belt; and the marking lines are denoted by different types if the potential risks are caused by atmosphere conditions, such as typhoon, floods, and tsunami. If the locations of the vendors or transportation paths from the factory 400 to the vendors have no potential risks or other issues, the marking lines are denoted by normal lines. In addition, the actual distances that correspond to aforementioned marking lines are also calculated, and the actual distances are marked around the marking lines on the digital map 310 so as to enable the factory owner of the production to estimate the degree of the risk during transportation. In addition, the carbon emission during the transportation also can be estimated.

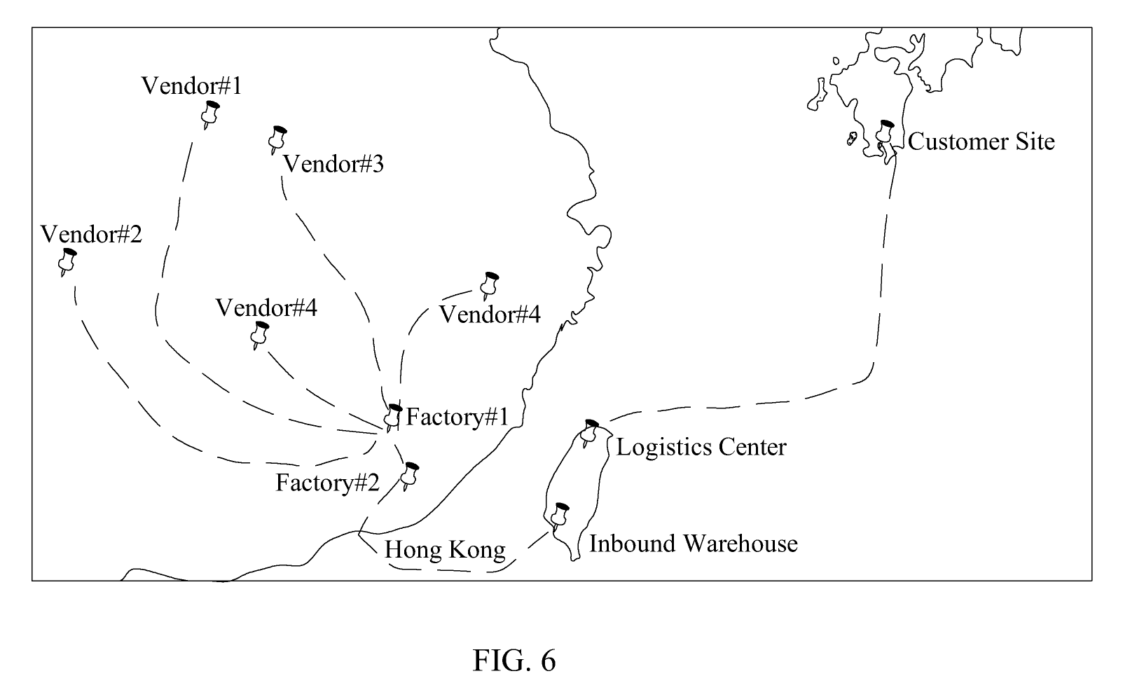

FIG. 6 is an actual view showing a supply chain structure on a digital map according to the present invention. As illustrated in FIG. 6, the supply chain structure is centered at a Factory#1 that fabricates a production, and five vendors (denoted as Vendor#1˜Vendor#5) are connected to the Factory#1 with respective marking lines on the digital map. In particular, the supply chain structure is characterized by the second factory#2, which implements an extra manufacturing process of the production, which is a finished production. Consequently, the finished production is delivered to stock at the inbound warehouse. Next, depending on the desire of the customer site, the production is transported to the customer site via a logistics center. According to the integrated supply chain structure of the present invention, via comparison of different supply chains of the same production, the integration of the supply chains of certain industries are more easily achieved. Therefore, the integrated supply chain structure can be utilized not only by the factories, but also the government and the research institutes.

On the other hands, the present invention further contains the information of reservoir and power plant that are supplied for the vendors, so that if there is a lack of reserved water in certain reservoir, the early response action can be utilized to prevent the interruption of the supply chain. As described in the present invention, the supply chain is varied by different external situations and time, such that the users can easily find out that whether the actual distances on the supply chain structure is getting longer or shorter or the supply distribution area is getting wider or narrower during a certain duration.

The descriptions set forth hereinbefore are simply exemplary rather than restrictive. All effectively equivalent modifications, changes or alternations made thereto without departing from the spirit and scope of the present invention are deemed as being encompassed by the field of the present invention defined as the following claims.

What is claimed is:

1. A supply chain digital map management system, comprising:
a site database of a plurality of basic records of a plurality of vendors;
an environment database of a plurality of geographical features and atmosphere conditions that correspond to a plurality of locations of said vendors; and
a processor communicated with said site database and said environment database, wherein said processor transfers a supply chain structure of a production into a digital map according to said site database and said environment database by inputting a plurality of vendor lists of said production.

2. The supply chain digital map management system of claim 1, wherein said basic records comprises longitude, latitude, and elevation information of said vendors.

3. The supply chain digital map management system of claim 1, wherein said geographical features comprise seismic belt distribution, geology, and soil condition data corresponding to locations of said vendors.

4. The supply chain digital map management system of claim 1, wherein said atmosphere conditions comprise typhoon, floods, and tsunami records corresponding to locations of said vendors.

5. The supply chain digital map management system of claim 1, wherein said supply chain structure of said production is indicated with different colors/types of marking lines to distinguish different potential risks from one another.

6. The supply chain digital map management system of claim 5, wherein said potential risks are seismic belt distribution, typhoon, floods, and tsunami.

7. The supply chain digital map management system of claim 5, wherein a plurality of actual distances that correspond to said marking lines are also calculated.

8. The supply chain digital map management system of claim 1, wherein said digital map is a three-dimension map.

9. The supply chain digital map management system of claim 1, wherein said vendor lists are BOM tables.

10. An integrating method for a supply chain digital map management system, comprising:
establishing a site database of a plurality of basic records of a plurality of vendors;
establishing an environment database of a plurality of geographical features and atmosphere conditions that correspond to a plurality of locations of said vendors; and
transferring a supply chain structure of a production into a digital map according to a plurality of vendor lists of said production, said site database, and said environment database.

11. The integrating method for a supply chain digital map management system of claim 10, wherein said basic records comprise longitude, latitude, and elevation information of said vendors.

12. The integrating method for a supply chain digital map management system of claim 10, wherein said geographical features comprise seismic belt distribution, geology, and soil condition data that correspond to said locations of said vendors.

13. The integrating method for a supply chain digital map management system of claim 10, wherein said atmosphere conditions comprise typhoon, floods, and tsunami records that correspond to said locations of said vendors.

14. The integrating method for a supply chain digital map management system of claim 10, wherein said supply chain structure of said production is indicated with different colors/types of marking lines to distinguish different potential risks from one another, wherein a plurality of actual distances that correspond to said marking lines are also calculated.

15. The integrating method for a supply chain digital map management system of claim 14, wherein said potential risks are seismic belt distribution, typhoon, floods, and tsunami.

16. The integrating method for a supply chain digital map management system of claim 10, wherein said digital map is a three-dimension map.

17. The integrating method for a supply chain digital map management system of claim 10, wherein said vendor lists are BOM tables.
